(19) United States
(12) Patent Application Publication
(10) Pub. No.: US 2006/0131357 A1
(43) Pub. Date: Jun. 22, 2006

(54) Cutting device provided in the handle of an adhesive-tape holder

(76) Inventor: Hsiu-Man Yu Chen, Taichung (TW)

Correspondence Address: TROXELL LAW OFFICE PLLC, 5205 LEESBURG PIKE, SUITE 1404, FALLS CHURCH, VA, 22041, US

(21) Appl. No.: 11/014,849

(22) Filed: Dec. 20, 2004

(51) Int. Cl. B26F 3/02; B65H 35/10

(52) U.S. Cl. 225/23

(57) ABSTRACT

A cutting device provided in the handle of an adhesive-tape holder has the interior of a handle formed with an accommodating space having a preset side cut with an inserting-and-extending slot. A safety cutter has its grip received in the accommodating space and the inserting-and-extending slot. The grip of the safety cutter has its lower end pivotally combined with a lower portion of the handle so that the grip of the safety cutter, with the pivotal combination portion acting as a pivot, can be turned to extend out of the inserting-and-extending slot. The grip of the safety cutter has its upper end cut with a lengthwise slot provided therein with a push-typed blade having its blade edge obliquely exposed in the lengthwise slot. Thus, packing strap positioned in the lengthwise slot can be cut off by pushing forward the safety cutter.

### BACKGROUND OF THE INVENTION

1. Field of the Invention

This invention relates to a cutting device provided in the handle of an adhesive-tape holder, particularly to one having a safety cutter installed in the handle of an adhesive-tape holder and able to be turned to extend out of the handle for cutting off packaging strap or packing wire by pushing forward the safety cutter.

2. Description of the Prior Art

Generally, an adhesive-tape holder is provided thereon with an adhesive-tape roll for releasing adhesive tape for gluing and packing articles. However, when articles that are originally packed by adhesive tape, by packaging strap or by packing wire have to be unpacked in order to be packed anew, some special cutting tools have to be employed for such unpacking work.

A conventional adhesive-tape holder has only one function of releasing adhesive tape for carrying out gluing and packing work, but has no cutting device provided thereon for cutting off adhesive tape or packaging strap or packing wire; therefore, a user has to prepare other cutting knives for carrying out tape cutting work, resulting in inconvenience in use. In addition, some special cutting knives have to be used for cutting off different-typed packing straps; therefore, a user has to prepare different kinds of cutting knives for occasional needs, and each individual knife is easy to be lost, giving rise to much trouble in use.

### SUMMARY OF THE INVENTION

The objective of the invention is to offer a cutting device provided in the handle of an adhesive-tape holder, having the interior of the handle formed with an accommodating space having a preset side cut with a lengthwise inserting-and-extending slot. A safety cutter having the lower end of its grip pivotally combined with a lower portion of the handle is received in the accommodating space and the inserting-and-extending slot of the handle. Thus, with the pivotally combination portion serving as a pivot, the grip of the safety cutter can be turned to extend out of the inserting-and-extending slot. The grip of safety cutter has its upper end cut with a lengthwise slot provided therein with a push-typed cutting blade having its blade edge obliquely exposed in the lengthwise slot for cutting off packing strap positioned in the lengthwise slot by pushing forward the safety cutter.

### BRIEF DESCRIPTION OF DRAWINGS

This invention will be better understood by referring to the accompanying drawings, wherein:

FIG. 1 is a perspective view of an adhesive-tape holder in the present invention:

FIG. 2 is an exploded perspective view of the adhesive-tape holder in the present invention:

FIG. 3 is a side cross-sectional view of a safety cutter and a retractable knife pushed to retract in the handle of the adhesive-tape holder in the present invention:

FIG. 4 is a side cross-sectional view of the safety cutter and the retractable knife pulled to extend out of the handle of the adhesive-tape holder in the present invention: and

FIG. 5 is a side cross-sectional view of the safety cutter turned to extend out of the handle and fixed in position in the present invention.

### DETAILED DESCRIPTION OF THE PREFERRED EMBODIMENT

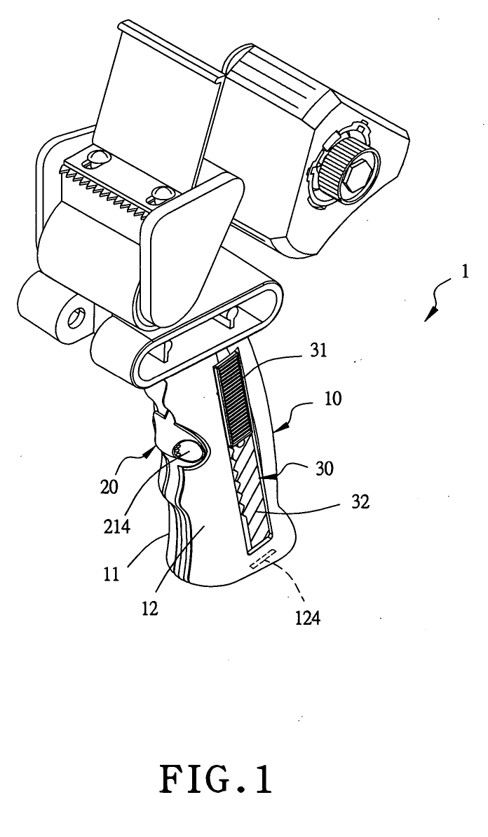

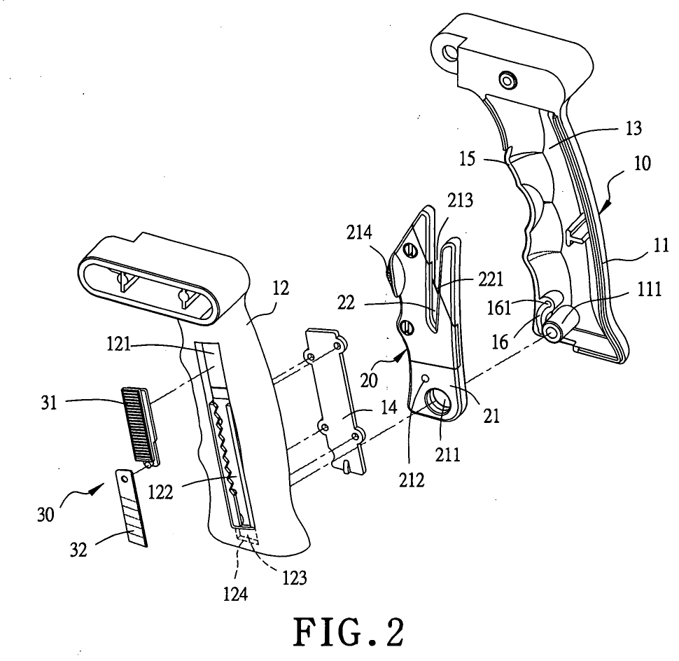

A preferred embodiment of a cutting device provided in the handle of an adhesive-tape holder in the present invention, as shown in FIGS. 1 and 2, includes a handle 10, a safety cutter 20 and a retractable knife 30 combined together.

The handle 10 consists of a basic body 11 and a cover body 12 combined together, having an accommodating space 13 formed in the interior. The basic body 11 has its lower inner side secured with a shaft 111 extending horizontally, and the cover body 12 has its outer side wall bored with an elongate groove 121 having its lower end connected with a slide base 122 having its lower side connected with a slide groove 123 extending downward and communicating with a groove opening 124 bored in the bottom of the cover body 12. The cover body 12 is provided with an inner cover plate 14 at the inner side for covering the inner sides of the elongate groove 121 and the slide base 122. In addition, the basic body 11 and the cover body 12 have their front coupling portion cut with a lengthwise inserting-and-extending slot 15 communicating with the accommodating space 13 of the handle 10. Further, the basic body 11 and the cover body 12 have their opposite inner sides respectively bored with an arc-shaped guiding recess 16 near the shaft 111 of the basic body 11, which acts as the center of the arc-shaped guiding recess 16. Each arc-shaped guiding recess 16 has its opposite ends respectively formed with a comparatively narrow contracted portion 161 having a function of positioning.

The safety cutter 20 is formed with a grip 21 able to be pushed inward and positioned in the accommodating space 13 and the inserting-and-extending slot 15 of the handle 10. The grip 21 of the safety cutter 20 has its lower end bored with a shaft hole 211 to be fitted around the shaft 111 at the lower end of the basic body 11 to enable the grip 21 of the safety cutter 20 to be turned to extend out of the inserting-and-extending slot 15. Further, the grip 21 of the safety cutter 20 has its opposite sides respectively secured with a positioning projection 212 at a proper location near the shaft hole 211 to be slidably engaged in the arc-shaped guiding recess 16 at the inner lower end of both the basic body 11 and the cover body 12 of the handle 10 and tightly fixed in position by either the contracted portions 161 at the opposite ends of the arc-shaped guiding recess 16. Furthermore, the grip 21 of the safety cutter 20 has its upper end cut with a lengthwise slot 213 provided therein with a push-typed cutting blade 22 having its blade edge 221 obliquely exposed in the lengthwise slot 213 for cutting off packing strap positioned in the lengthwise slot 213 by pushing forward the safety cutter 20. The grip 21 of the safety cutter 20 is also provided with a pull member 214 at the front side near the upper end for pulling the safety cutter 20 outward for use.

The retractable knife 30 is composed of a push button 31 and a cutting blade 32. The push button 31 is received in the elongate groove 121 of the cover body 12 of the handle 10 and engaged with the slide base 122 to slide together. The blade 32 is fastened at the front end of the push button 31 to slide together with the push button 31, able to be actuated to extend out of or move back into the groove opening 124 at the bottom of the handle 10.

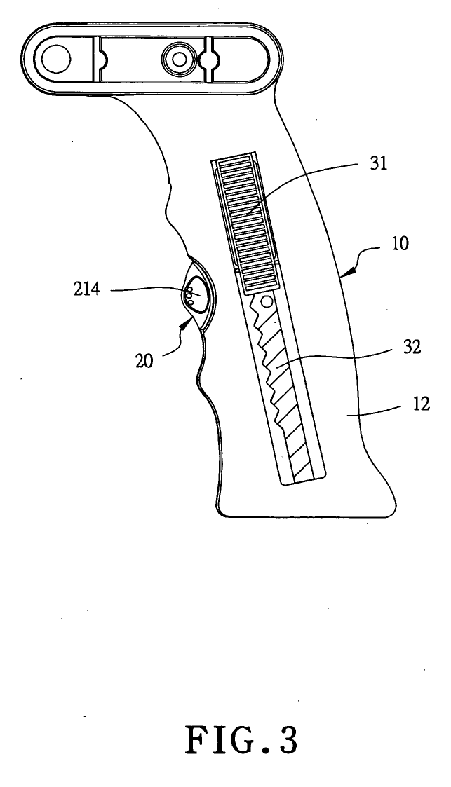

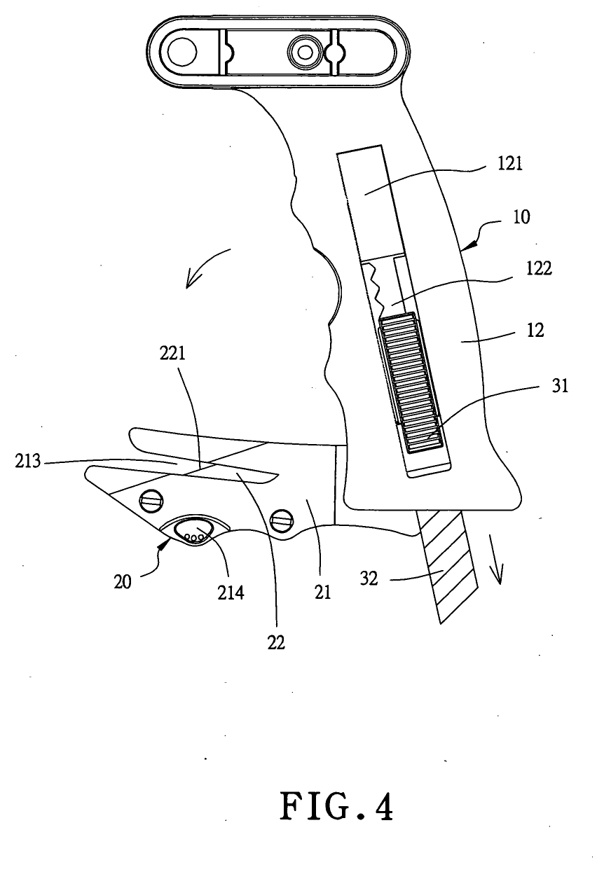

The cutting device provided in the handle of an adhesive-tape holder has two kinds of cutting functions described below, with FIGS. 3 and 4 referred.

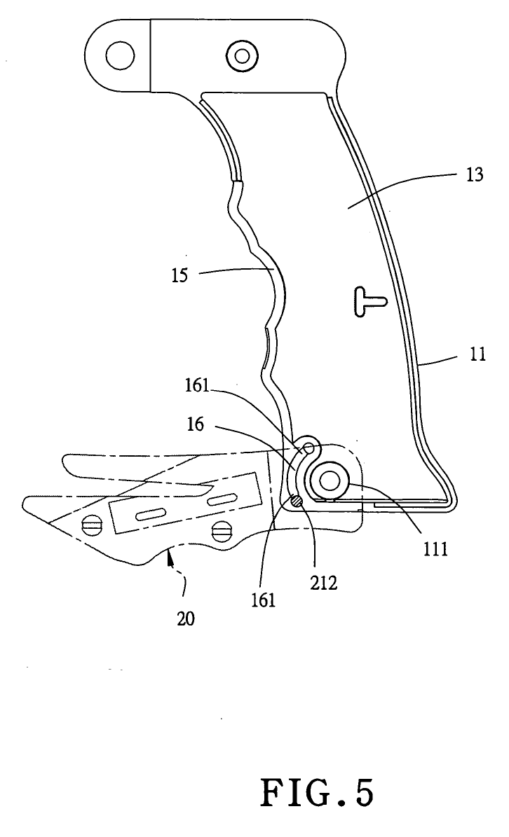

(1) The pull member 214 of the grip 21 of the safety cutter 20 is pulled outward to actuate the safety cutter 20 to extend out of the handle 10 for use. Since the safety cutter 20 has its lower end pivotally combined with the handle 10, and the grip 21 of the safety cutter 20 is provided with positioning projections 212 respectively fitted in the arc-shaped guiding recesses 16 of the handle 10 and guided to slide therein; therefore, the safety cutter 20 can be smoothly turned to extend out of the handle 10. When the safety cutter 20 is turned to extend outward, the positioning projections 212 on its grip 21 will be respectively moved to reach the ends of the arc-shaped guiding recesses 16 and tightly fixed in position by the contracted portions 161 of the arc-shaped guiding recesses 16 to prevent the safety cutter 20 from swinging, as shown in FIG. 5. After the safety cutter 20 is pulled outward and fixed in position, its lengthwise slot 213 in the outer end is adjusted in alignment with the packaging strap or the packing wire to be cut off and then the safety cutter 20 is pushed forward to let the packaging strap or the packing wire moved in the lengthwise slot 213 and cut off by the oblique blade edge 221 inside the lengthwise slot 213.

(2) When the cutting device provided in the handle of an adhesive-tape holder is used to cut off packing adhesive tape, simply push downward the push button 31 of the retractable knife 30 to make the blade 32 of the retractable knife 30 extend out of the bottom of the handle 10 through the groove opening 32 for cutting off the packing adhesive tape.

As can be understood from the above description, this invention has the following advantages.

1. The handle 10 of the adhesive-tape holder 1 is provided therein with two different-typed cutting devices: the safety cutter 20 and the retractable knife 30, able to be respectively employed for cutting off packaging strap, packing wire or packing adhesive tape.

2. The safety cutter 20 has its lower end pivotally combined with a lower portion of the handle 10 and its opposite sides respectively fixed with a positioning projection 212 fitted in the arc-shaped guiding recess 16 of the handle 10 and guided to slide therein; therefore, the safety cutter 20 can be pulled to extend out of or pushed into the handle 10 steadily and smoothly. In addition, the arc-shaped guiding recess 16 of the handle 10 has its opposite ends respectively formed with a contracted portion 161. Thus, when the safety cutter 20 is pulled to extend outward or pushed to retract inward, it can be firmly fixed in position by the contracted portions 161 of the arc-shaped guiding recesses 16 of the handle 10.

3. Both the safety cutter 20 and the retractable knife 30 can be pushed to retreat in the handle 10 so it is absolutely safe when they are not in use, avoiding accident of cutting and preventing the cutting device from being damaged.

While the preferred embodiment of the invention has been described above, it will be recognized and understood that various modifications may be made therein and the appended claims are intended to cover all such modifications that may fall within the spirit and scope of the invention.

I claim:

1. A cutting device provided in the handle of an adhesive-tape holder comprising:
A handle formed with an accommodating space in the interior, said accommodating space having one preset side cut with a lengthwise inserting-and-extending slot: and
A safety cutter formed with a grip, said grip of said safety cutter received in said accommodating space and said inserting-and-extending slot of said handle, said grip of said safety cutter having its lower end pivotally combined with a lower portion of said handle, with the lower pivotal combination portion acting as a pivot, said grip of said safety cutter able to be turned to extend out of said inserting-and-extending slot, said grip of said safety cutter having its upper end cut with a lengthwise slot, said lengthwise slot provided therein with a push-typed knife, said push-typed knife having its blade edge obliquely exposed in said lengthwise slot, said obliquely exposed blade edge of said push-typed knife able to cut off packing strap positioned in said lengthwise slot by pushing forward said grip of said safety cutter.

2. The cutting device provided in the handle of an adhesive-tape holder as claimed in claim 1, wherein said grip of said safety cutter has at least one side provided with a positioning projection near said pivotal combination portion, and said handle is bored with an arc-shaped guiding recess having said pivotal combination portion serving as a center for said positioning projection of said grip of said safety cutter to be engaged and slide therein, said arc-shaped guiding recess having its opposite ends respectively formed with a comparatively narrow contracted portion, said narrow contracted portions of said arc-shaped guiding recess able to fix said positioning projections of said grip of said safety cutter in position when said positioning projections slides to reach said narrow contracted portions of the arc-shaped guiding recesses.

3. The cutting device provided in the handle of an adhesive-tape holder as claimed in claim 1, wherein said grip of said safety cutter has an upper portion provided with a pull member at a proper location for pulling said grip of said safety cutter outward.

4. The cutting device provided in the handle of an adhesive-tape holder as claimed in claim 1, wherein said grip of said safety cutter has said pivotal combination portion bored with a shaft hole, and said handle has a corresponding portion secured with a shaft to be inserted in said shaft hole of said grip of said safety cutter.

5. The cutting device provided in the handle of an adhesive-tape holder as claimed in claim 1, wherein a retractable knife with a blade is provided at an outer side of said handle, and said handle has its bottom bored with a groove opening so that said blade of said retractable knife can be pushed downward to extend out of said groove opening for cutting off adhesive tape.

6. The cutting device provided in the handle of an adhesive-tape holder as claimed in claim 5, wherein said handle comprises a basic body and a cover body combined together, said cover body bored with an elongate groove in one preset side, said elongate groove having its lower end connected with a slide base, said slide base having its lower end connected with a slide groove, said slide groove communicating with said groove opening bored in the bottom of said handle, said cover body having an inner cover plate secured at the inner side, said inner cover plate covering the inner sides of both said elongate groove and said slide base, said retractable knife provided with a push button having its front end fastened with said blade, said push button received in said elongate groove of said cover body and fitted with said slide base, said push button pushed to slide together with said slide base and make said blade extend out of or retreat into said groove opening of said cover body.
